(19) United States
(12) Patent Application Publication
(10) Pub. No.: US 2025/0030125 A1
(43) Pub. Date: Jan. 23, 2025

(54) SEPARATOR AND BATTERY CELL

(71) Applicant: ZHUHAI COSMX BATTERY CO., LTD., Zhuhai (CN)

(72) Inventors: Donghui SHENG, Zhuhai (CN); Peilun LIU, Zhuhai (CN); Chunyu LIU, Zhuhai (CN); Jichun XIE, Zhuhai (CN)

(73) Assignee: ZHUHAI COSMX BATTERY CO., LTD., Zhuhai (CN)

(21) Appl. No.: 18/910,431

(22) Filed: Oct. 9, 2024

Related U.S. Application Data
(63) Continuation of application No. PCT/CN2023/116186, filed on Aug. 31, 2023.

(30) Foreign Application Priority Data
Oct. 31, 2022 (CN) 202222878393.9

(51) Int. Cl. H01M 50/463; H01M 10/04

(52) U.S. Cl. CPC H01M 50/463; H01M 10/0431

(57) ABSTRACT

Disclosed are a separator and a battery cell. The separator is used for being winded together with an electrode plate to prepare a battery cell, and the separator includes: a first section, a second section and a third section which are sequentially arranged in a length direction of the separator. A width of the first section is less than a width of the second section, and/or, a width of the third section is less than the width of the second section.

### CROSS-REFERENCE TO RELATED APPLICATIONS

The present application is a continuation of International Application No. PCT/CN2023/116186, filed on Aug. 31, 2023, which claims priority to Chinese Patent Application No. 202222878393.9, filed on Oct. 31, 2022. The disclosures of the aforementioned applications are hereby incorporated by reference in their entireties.

### TECHNICAL FIELD

The present disclosure relates to the field of batteries technologies, and in particular, to a separator and a battery cell.

### BACKGROUND

A secondary battery generally includes a battery cell and an outer housing. The battery cell is mainly classified into a stacked type battery cell and a wound type battery cell according to different preparation processes. The wound type battery cell is a flat battery cell made by winding an electrode plate and a separator which are hold by a winding needle adopting a winding process. Manufacturing the wound type battery cell based on a conventional separator has a problem of poor battery cell quality.

### SUMMARY

The purpose of the present disclosure is to provide a separator and a battery cell for improving battery quality.

Embodiments of the present disclosure provide a separator. The separator includes: a first section, a second section and a third section which are sequentially arranged along a length direction of the separator. A width of the first section is less than a width of the second section, and/or, a width of the third section is less than a width of the second section.

It can be learned from the foregoing technical solution that, according to the present disclosure, the separator is divided into areas with different widths to make a width of the area located at a head of the separator and/or a width of the area located at a tail is less than a width of the middle area of the separator. After the width of the head of the separator is narrowed, a contact area between the separator and a winding needle may be reduced, so that a friction force between a surface of the separator and the winding needle is reduced to prevent a portion of the separator from being pulled out of a battery cell when the winding needle is pulled out, and thus a problem of core pulling of the separator is solved. When the width of the tail of the separator is narrowed, that is, a width of an outer circle of the separator is reduced, so that a swing amplitude of the tail of the separator may be reduced at the winding termination of the separator, and thus a problem of wrinkling of the separator at the winding termination of a jellyroll is solved. The quality of a battery may be improved by solving the problem of the core pulling of the separator and/or the problem of the wrinkling of the separator at the winding termination of the jellyroll.

In some optional embodiments, the width of the first section, in an extension direction from an end of the first section away from the second section to an end of the first section close to the second section, is increased gradually.

In a direction that the first section away from the second section, the first section is arranged to gradually narrow, which not only ensure that the two electrode plates may be isolated from each other, but also reduce the contact area between the separator and the winding needle, so that the friction force between the surface of the separator and the winding needle is reduced, and thus the core pulling of the separator is improved.

In some optional embodiments, the width of the third section, in an extension direction from an end of the third section away from the second section to an end of the third section close to the second section, is increased gradually.

By narrowing a width of the tail of the separator, that is, reducing the width of the outer circle of the separator, so that the swing amplitude of the tail of the separator may be reduced at the winding termination of the separator, and thus the wrinkling of the separator at the winding termination of the jellyroll is improved.

The embodiments of the present disclosure also provide a battery cell including two electrode plates having opposite polarities and separators disposed between the two electrode plates. The separators and the two electrode plates are disposed in a stacked manner and are winded to form a battery cell. The separators are the separator according to any one of the above-mentioned embodiments, and the first section of the separator is located at a winding head end of the battery cell.

In some optional embodiments, a length w1 of the first section of the separator satisfies: 10%*W≤w1≤3*W, where W is a width of the battery cell.

In some optional embodiments, a length w2 of the third section of the separator satisfies: 10%*W≤w2≤3*W.

In some optional embodiments, a length w2 of the third section of the separator satisfies: 10%*W≤w2≤3*W, where W is a width of the battery cell.

In some optional embodiments, a projection, on a plane where the separator is located, of at least one of the two electrode plates is located in the separator.

In some optional embodiments, on a side of the separator in a width direction of the separator, a distance between an outer edge of the second section of the separator and an outer edge of at least one of the two electrode plates is H, and H is less than or equal to 0.2 mm.

In some optional embodiments, on the side of the separator in the width direction of the separator, a distance h1 between an outer edge of the first section of the separator and the outer edge of the two electrode plates satisfy: 3%*H≤h1≤97%*H.

In some optional embodiments, a relationship between a minimum width h2 of the first section and a width h3 of the electrode plate satisfies: 50%*h3≤h2≤h3+h1.

In some optional embodiments, on the side of the separator in the width direction of the separator, a distance h4 between an outer edge of the third section of the separator and the outer edge of the electrode plate satisfies: 3%*H≤h4≤97%*H.

In some optional embodiments, a relationship between a minimum width h5 of the third section and a width h3 of the electrode plate satisfies: 50%*h3≤h5≤h3+h4.

In some optional embodiments, at least one of the two electrode plates includes an uncovered foil region and a tab disposed on the uncovered foil region. A projection, on a plane where the separator is located, of a portion of the tab on the electrode plate is located in the first section.

In some optional embodiments, the two electrode plates include a first electrode plate and a second electrode plate, and the separators includes a first separator and a second separator which are located at two opposite sides of the first electrode plate. The first separator and the second separator cover the first electrode plate, and the first separator, the first electrode plate and the second separator are bonded together.

In some optional embodiments of the application, lengths of the first separator and the second separator are the same.

### BRIEF DESCRIPTION OF THE DRAWINGS

In order to more clearly illustrate the embodiments of the present disclosure, the drawings to be used in the description of the embodiments or conventional art will be briefly introduced below, and it is obvious that the drawings in the following description are merely some of the embodiments of the present disclosure. For a person skilled in the art, other drawings may be obtained based on these drawings without creative labor.

FIG. 1 shows a schematic structural diagram of a wound type battery cell provided in an embodiment of the present disclosure.

FIG. 2 shows a schematic diagram of core pulling of a wound type battery cell provided in an embodiment of the present disclosure.

FIG. 3 shows a schematic structural diagram of a separator provided in an embodiment of the present disclosure.

FIG. 4 shows a schematic diagram of separators and electrode plates disposed in a stacked manner provided in an embodiment of the present disclosure.

FIG. 5 shows a schematic diagram of electrode plates and separators disposed in a stacked manner provided in another embodiment of the present disclosure.

Specific implementation modes of the present disclosure are described in further detail below with reference to the drawings.

### DETAILED DESCRIPTION OF THE EMBODIMENTS

The present disclosure will be described in detail below with reference to the drawings. When the embodiments of the present disclosure are described in detail, for ease of explanation, the drawings representing a structure of a device will not be locally enlarged according to general proportion, and the schematic diagrams are merely examples, which should not limit the protection scope of the present disclosure. It should be noted that the drawings are adopted a simplified form and are all use non-precise proportions, and are used only for the purpose of conveniently and clearly assisting in the illustration of the embodiments of the present disclosure. In addition, in the description of the present disclosure, terms “first”, “second” and the like are only used to distinguish the description, and cannot be understood as indicating or implying relative importance or implicitly indicating the number of indicated technical features. Orientations or positional relationships indicated by terms “positive”, “reverse”, “bottom”, “upper”, “lower” and the like are the orientations or positional relationships based on the orientations or positional relationships shown in the drawings, which are merely intended to facilitate describing the present disclosure and simplify the description, rather than indicating or implying that the device or element referred to must have a particular orientation, or be constructed and operated in a particular orientation, therefore cannot be understood as a limitation to the present disclosure.

In the description of the present disclosure, it should be noted that, unless expressly specified and limited otherwise, terms “connected” and “connect” should be understood in a broad sense, for example, the connection may be fixed, detachable or integral connection; it may be mechanical or electrical connection; it may be a direct connection, an indirect connection through an intermediate medium, or it may be communication inside two elements; it may be wireless connection or wired connection. For a person skilled in the art, the specific meaning of the above-mentioned terms in present disclosure may be understood according to a specific case.

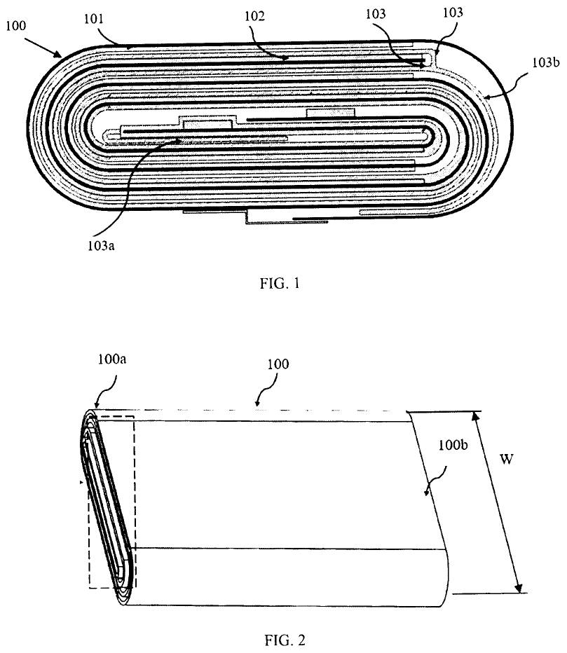

FIG. 1 and FIG. 2 are schematic structural diagrams of a battery cell made by a winding process. As shown in FIG. 1 and FIG. 2, a wound type battery cell 100 is formed by winding a positive electrode plate 101, a negative electrode plate 102, and a separator 103. The separator 103 is disposed between the positive electrode plate 101 and the negative electrode plate 102 to separate the positive electrode plate 101 from the negative electrode plate 102. Positive tabs (not labeled) and negative tabs (not labeled) are disposed on the positive electrode plate 101 and the negative electrode plate 102, respectively. During winding, a head 103a the separator 103 is bent and overlapped, and is located in the innermost layer of the wound type battery cell 100. The wound type battery cell 100 has a head 100a and a tail 100b, and a winding needle is pulled out from a side where the head 100a of the wound type battery cell 100 is located after winding is completed. The separator 103 in the wound type battery cell is located at the innermost layer of the battery cell, and a winding needle holds the separator and drives the electrode plate to wind together through the separator during winding. Since the separator 103 has a portion which is in direct contact with the winding needle, there is a friction force between a surface coating of the portion of the separator and the winding needle. After the winding is completed, during a process that the winding needle is pulled out, the winding needle is easily pulled out together with the separator in an inner layer, so that a portion of the separator is pulled out of the battery cell, and thus resulting in a phenomenon of core pulling. For example, the separator is partially pulled out of the head of the battery cell (as a portion within a dashed box shown in FIG. 2). When the separator is pulled out, it will affect the mutual isolation between the positive electrode plate 101 and the negative electrode plate 102, which may cause the positive and negative electrode plates being in contact with each other to generate a short circuit, and even cause the core being scrapped, so that a product yield is reduced. In addition, for some wound type battery cells ending with the separator, since a width of the separator is wider and texture is softer, the tail of the separator 103b is easily wrinkled during winding termination, resulting in an increase in a thickness of the wound type battery cell, thereby an energy density of the battery is affected.

A wound type battery cell is a battery cell made by a winding process, the wound type battery cell includes two electrode plates with opposite polarities, and a separator is located between the two electrode plates. During winding, the winding needle holds the separator and the electrode plates disposed in the stacked manner to be winded together to form the battery cell. For ease of explanation, an end of the separator 103 located at the innermost layer of the battery cell is defined as the head of the separator, and the other end of the separator opposite to the head is the tail of the separator. In some winding processes, the separator is used for winding termination, that is, the tail of the separator will be wrapped outside the outermost layer of the battery cell. The innermost layer of the battery cell is also a winding head end of the battery cell.

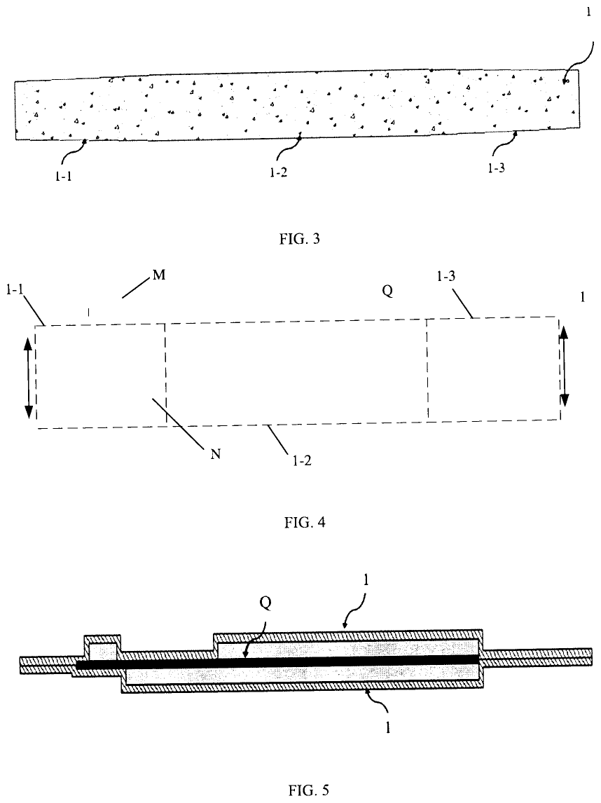

A separator is generally in a rectangular structure, a size of a long edge of a rectangle is defined as a length of the separator, and a size of a short edge of the rectangle is defined as a width of the separator. As shown in FIG. 3 and FIG. 4, an embodiment of the present disclosure provides a separator 1. The separator 1 includes a first section 1-1, a second section 1-2 and a third section 1-3 which are sequentially arranged along a length direction of the separator 1. The first section 1-1 is located on a side of a head of the separator, that is, during winding, the first section 1-1 is located at a winding head end of a battery cell, that is, it is located in an inner layer of the battery cell. The third section 1-3 is located on a side of a tail of the separator, that is, during winding, the third section 1-3 is located on an outer layer of the battery cell. A width of the first section 1-1 is less than a width of the second section 1-2, and/or a width of the third section 1-3 is less than a width of the second section 1-2, so that the separator has a shape with an end portion narrower than a middle portion thereof.

In some embodiments, the width of the first section 1-1 and the width of the third section 1-3 are both less than the width of the second section 1-2, and the width of the first section 1-1 is increased gradually in an extension direction from an end of the first section 1-1 away from the second section 1-2 to an end of the first section 1-1 close to the second section 1-2, that is, the first section 1-1 is increasingly narrower in a direction the first section 1-1 away from the second section 1-2; and/or, the width of the third section 1-3 is also increased gradually in an extension direction from an end of the third section 1-3 away from the second section 1-2 to an end of the third section 1-3 close to the second section 1-2, that is, the third section 1-3 is increasingly narrower in a direction the third section 1-3 away from the second section 1-2. In order to ensure that the positive and negative electrode plates are separated, a width of a narrowest position of the separator 1, that is, a minimum width of the separator 1 is greater than a width of the electrode plate (positive and/or negative electrode plate). That is, when the electrode plate and the separator are flattened and stacked together, a projection, on a plane where the separator is located, of the electrode plate is located in the separator (as shown in FIG. 4). In this way, it may be ensured that when the separator and the electrode plate are disposed in the stacked manner or winded, the separator is capable of completely covering the electrode plate, and thereby the electrode plates with opposite polarities separated by the separator are prevented from contacting each other.

In the present disclosure, by dividing the separator into areas with different widths, the width of the area (the first section) located at the head of a separator and/or the area (the third section) located at the tail of the separator is less than the width of the middle position of the separator. The width of the head of the separator is narrowed, so that a contact area of the separator and the winding needle may be reduced, and thereby a friction force between a surface of the separator and the winding needle is reduced, which prevents a portion of the separator from being pulled out of the battery cell when the winding needle is pulled out, and thus the problem of core pulling of the separator is solved. In some embodiments, a width of a tail area of a separator is also less than a width of other portions of the separator, so that a swing amplitude of the tail of the separator may be reduced at the winding termination of the separator, and thus wrinkling of the separator at the winding termination of a jellyroll is improved.

An embodiment of present disclosure further provides a battery cell, including two electrode plates with opposite polarities and separators located between the two electrode plates, and the separators and the two electrode plates are disposed in a stacked manner and winded to form the battery cell. The separator may be the separator according to any one of the foregoing embodiments, and the first section of the separator is located at a winding head end of the battery cell.

In some embodiments, the battery cell includes a first electrode plate and a second electrode plate with opposite polarities, the separators include a first separator and a second separator located on two opposite sides of the first electrode plate, and the first separator and the second separator cover the first electrode plate. As shown in FIG. 5, as an optional implementation of the present disclosure, before winding the first electrode plate, the second electrode plate and the first and second separators, the first electrode plate and the first and second separators located on surfaces of two sides of the first electrode plate may be laminated and bonded together, and then the first electrode plate laminated with the separators and the second electrode plate are stacked for winding. In some optional embodiments, the first separator and the second separator respectively located on two opposite sides of the first electrode plate are equal in length, and adopting the two separators with the same length may avoid dislocation during winding.

As shown in FIG. 4, the separator 1 is longer than an electrode plate Q, and is also wider than the electrode plate Q, and the separator 1 exceeds the electrode plate Q in a length direction and a width direction. In some embodiments, in a width direction of the separator, a distance between an outer edge of a second section 1-2 of the separator 1 and an outer edge of the electrode plate Q on the same side is H, where H≥0.2 mm. That is, in the width direction, sizes that two sides of the separator 1 at the second section 1-2 exceed the electrode plate Q are H, respectively. That is, the two sides of the separator 1 at the second section 1-2 respectively exceed the electrode plate 0.2 mm.

A length w1 of the first section 1-1 of the separator 1 satisfies: 10%*W≤w1≤3*W, where W is a width of a battery cell. In the width direction of the separator 1, a distance between an outer edge of the first section 1-1 and an outer edge of the electrode plate Q on the same side is h1, and 3%*H≤h1≤97%*H. That is, on one side in the width direction, the first section 1-1 of the separator 1 exceeds at least h1 beyond the electrode plate the. When the width of the first section 1-1 decreases gradually in a direction the first section 1-1 away from the second section 1-2, the h1 is a value range rather than a constant value. When the first section 1-1 is a square region with a constant width, the h1 is a constant value. A relationship between a minimum width value h2 of the first section 1-1 and a width h3 of the electrode plate Q also satisfies: 50%*h3≤h2≤h3+h1, where the h3 in the formula is a width of the electrode plate.

A length w2 of a third section 1-3 of the separator 1 satisfies: 10%*W≤w2≤3*W. In the width direction, a distance between an outer edge of the third section 1-3 and an outer edge of the electrode plate Q on the same side is h4, and 3%*H≤h4≤97%*H. That is, in the width direction, sizes that the two sides of the separator 1 at the third section 1-3 exceed a size of the electrode plate Q are h4, respectively. Similarly, when the width of the third section 1-3 decreases gradually in a direction the third section 1-3 away from the second section 1-2, the h4 is a value range rather than a constant value. When the third section 1-3 is a square area with a constant width, the h4 is a constant value. A relationship between a minimum width value h5 of the third section 1-3 and a width h3 of the electrode plate Q also satisfy: 50%*h3≤h5≤h3+h4.

As shown in FIG. 4, the electrode plate Q has an uncovered foil region N which is uncoated with an active material, and the uncovered foil region N is used for welding a tab M. The tab M is disposed in the uncovered foil region N of the electrode plate Q, and extends beyond the electrode plate Q in the width direction of the separator 1. After the tab M is disposed on the electrode plate Q, a projection of a portion of the tab M on the electrode plate Q (a part of the tab that does not extend beyond the electrode plate) on a plane where the separator 1 is located is located in the first section 1-1 of the separator 1. That is, a projection of the uncovered foil region N of the electrode plate Q on the plane where the separator 1 is located is located in the first section 1-1 of the separator 1.

The above description of the disclosed embodiments enables a person skilled in the art to implement or use the present disclosure. Various modifications to these embodiments will be apparent to a person skilled in the art, and general principles defined herein may be implemented in other embodiments without departing from the spirit or scope of the present disclosure. Thus, the present disclosure will not be limited to the embodiments shown herein but is to be accorded the widest scope consistent with the principles and novel features disclosed in the present specification.

What is claimed is:

1. A separator, comprising:
a first section, a second section, and a third section which are sequentially arranged along a length direction of the separator, wherein a width of the first section is less than a width of the second section.

2. The separator according to claim 1, wherein a width of the third section is less than the width of the second section.

3. The separator according to claim 1, wherein the width of the first section, in an extension direction from an end of the first section away from the second section to an end of the first section close to the second section, is increased gradually.

4. The separator according to claim 1, wherein the width of the third section, in an extension direction from an end of the third section away from the second section to an end of the third section close to the second section, is increased gradually.

5. A battery cell, comprising: two electrode plates having opposite polarities and separators disposed between the two electrode plates, the separators and the two electrode plates being disposed in a stacked manner and being winded to form the battery cell, wherein the separators are the separator according to claim 1, and the first section of the separator is located at a winding head end of the battery cell.

6. The battery cell according to claim 5, wherein a length w1 of the first section satisfies: 10%*W≤w1≤3*W, wherein W is a width of the battery cell.

7. The battery cell according to claim 6, wherein a length w2 of the third section satisfies: 10%*W≤w2≤3*W.

8. The battery cell according to claim 5, wherein a length w2 of the third section satisfies: 10%*W≤w2≤3*W, wherein W is a width of the battery cell.

9. The battery cell according to claim 5, wherein a projection, on a plane where the separator is located, of at least one of the two electrode plates is located in the separator.

10. The battery cell according to claim 5, wherein on a side of the separator in a width direction of the separator, a distance between an outer edge of the second section of the separator and an outer edge of at least one of the two electrode plates is H, and His less than or equal to 0.2 mm.

11. The battery cell according to claim 10, wherein on the side of the separator in the width direction of the separator, a distance h1 between an outer edge of the first section of the separator and the outer edge of the electrode plate satisfies: 3%*H≤h1≤97%*H.

12. The battery cell according to claim 11, wherein a relationship between a minimum width h2 of the first section and a width h3 of the electrode plate satisfies: 50%*h3≤h2≤h3+h1.

13. The battery cell according to claim 10, wherein on the side of the separator in the width direction of the separator, a distance h4 between an outer edge of the third section of the separator and the outer edge of the electrode plate satisfies: 3%*H≤h4≤97%*H.

14. The battery cell according to claim 13, wherein a relationship between a minimum width h5 of the third section and a width h3 of the electrode plate satisfies: 50%*h3≤h5≤h3+h4.

15. The battery cell according to claim 5, wherein,
at least one of the two electrode plates comprises an uncovered foil region and a tab disposed on the uncovered foil region, and a projection on a plane where the separator is located, of a portion of the tab on the electrode plate is located in the first section.

16. The battery cell according to claim 5, wherein the two electrode plates comprise a first electrode plate and a second electrode plate, the separators comprise a first separator and a second separator which are located at two opposite sides of the first electrode plate, the first separator and the second separator cover the first electrode plate, and the first separator, the first electrode plate and the second separator are bonded together.

17. The battery cell according to claim 16, wherein lengths of the first separator and the second separator are the same.
